(19) United States
(12) Patent Application Publication
(10) Pub. No.: US 2004/0222623 A1
(43) Pub. Date: Nov. 11, 2004

(54) Sealing assembly for a steering column assembly

(76) Inventor: Paul A. Walters, Fort Wayne, IN (US)

Correspondence Address: George R. Royer, Suite 416, 316 N. Michigan Street, Toledo, OH, 43624, US

(21) Appl. No.: 10/428,518

(22) Filed: May 5, 2003

(51) Int. Cl. B62D 1/16

(52) U.S. Cl. 280/779

(57) ABSTRACT

The subject invention is a flexible sealing structure for an automobile steering column that is formed and adapted as an external sealing mechanism which sealing mechanism has a housing having an internal circumference which has formed thereon an internal circumferential flange, as opposed to having formed thereon a circumferential channel on the radially inner surface of the housing. The internal circumferential seal member is affixed on the outer circumferential surface of the internal circumference flange. The sealing concept herein has other applications aside from the steering column of an automobile as set forth in the preferred embodiment.

### D. DISCUSSION OF PRIOR ART AND BACKGROUND OF INVENTION

The subject invention is conceived and there are many devices conceived to provide a more efficient sealing mechanism to prevent air, moisture, dirt, or other substances reaching the working mechanisms of the steering column. Specifically, the applicable area of the art relates to sealing members located on the steering column of a motor vehicle just immediately in front of the fire wall of a motor vehicle. Such devices have application to other areas wherein circumferentially sealing requirements prevail.

In particular, in steering columns on motor vehicles there are numerous maintenance problems that are of vital concern to both safety and wear considerations. Both of these concerns are directly related and substantially dependent on proper protection of the steering columns for its proper safe operation. It is not an overstatement to indicate that a steering column subjected to extreme wear and poor maintenance has a potential for abrupt failure. Obviously, relative to the safety and integrity aspects, steering column safety is one of the paramount considerations for vehicular safety.

In this latter aspect, it is significant to take notice of steering column failures are a significant cause of vehicular accidents throughout the country. These failures have caused a deadly toll of lives, personal injury, and property damage. The largest problem in this respect as stated has been improper maintenance quality resulting in disintegration of the steering column structured in the vehicle. These cited aspect may be caused in part by improper sealing means in the housing that surrounds the steering column at that portion just in front of the firewall.

### E. OBJECTS OF THE INVENTION

The following are objects of the subject invention:

It is an object of the subject invention to provide an improved structure for maintenance of a steering mechanism;

It is also and object of the subject invention to provide an improved means to seal a steering column at where it projects in front of a firewall;

An additional object of the subject invention is to provide an improved structure and means to maintain proper protection on a motor vehicle steering column;

A further object of the subject invention is to set forth an efficient mechanism for keeping foreign elements out of the internal moving mechanism of a steering column;

Yet, another aspect of the subject invention is to provide an improved device to seal the working mechanisms of a steering column;

A further object of the subject invention is to provide an improved structure for maintaining cleanliness levels on a steering column of a motor vehicle;

Other and further objects of the subject invention can be seen in the following description and claims read in view of the drawings.

### F. IN THE DRAWINGS

FIG. 1 is a perspective view of the prior art sealing mechanism, shown partially cut-away;

FIG. 2 is a perspective view of the overall housing and sealing member incorporating the subject invention as placed around a steering column.

### G. DESCRIPTION OF GENERAL EMBODIMENT AND SUMMARY OF INVENTION

In an overall perspective, the subject invention is an improved mechanism for maintaining and protecting a steering column of a motor vehicle from dust, moisture, or other elements. The invention is focused on a sealing mechanism that is circumferentially external to the steering column and has an internal radial flange on the radially inner surface of the outer rigid housing surrounding the steering column. As stated previously such sealing unit functions to keep out dirt, moisture and other substances from the steering column assembly as well as ensuring that dust and moisture do not enter the passenger area of the motor vehicle. It is noted that the subject invention can be made applicable to other types of devices, not just steering columns in motor vehicles, as the principles of this invention have wide application to other areas, particularly where a circumferentially surrounding seal is needed.

The subject apparatus is contemplated to utilize a housing member to surround the steering column at the fire wall between the engine compartment and passenger area of a motor vehicle. Instead of a radially internal channel on the inner circumferential surface of the housing that projects radially inwardly towards inner central diameter of the housing. The improved structure herein contemplates use of a housing that has an internal circumferential disposed flange that projects radially inwardly towards the inner center of the housing. In this general embodiment an annular seal is affixed circumferentially against the inner radial surface of the housing with the seal having an outer radially circumferentially disposed channel which is adapted to matingly engage against the inner circumferential flange on the upper radial parts of the housing.

The advantage with this invention is that there is more efficient sealing and protection by the subject concept, as opposed to prior art designs.

### H. DESCRIPTION OF PREFERRED EMBODIMENT

In describing the preferred embodiment of the subject invention, one preferred embodiment will be set forth. However, a description of one limited embodiment of the subject invention will not be considered as limiting the scope of the subject invention, as set forth in the claims, to only one such embodiment.

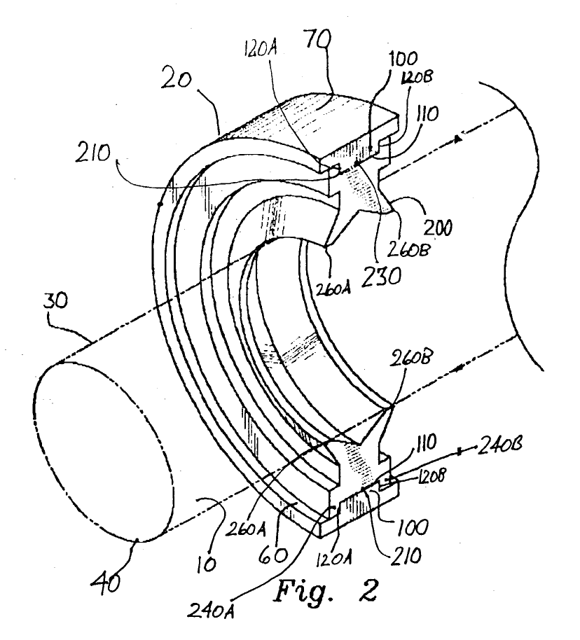

Referring now to the drawings in which a preferred embodiment is shown, as seen in FIG. 2 is a conventional steering column 10 is shown as positioned in a motor vehicle. Steering column 10 is comprised of rigid cylindrical member on which is mounted a steering wheel, not shown. In most motor vehicles, at the juncture where the column 10 extends through the firewall of a vehicle a housing member 20 is positioned on the steering column 10. This housing member 20 is equipped with sealing means to protect the ingress of moisture and dirt from the engine compartment to upper portions of the steering column. As seen the steering column 10 has an outer circumferential surface 30 and an upper end 40. Moreover, as seen in FIG. 9, the steering column is generally shown as a cylindrical member having such outer circumferential surface 30.

In the preferred embodiment of the subject invention seen in FIG. 2 of the drawings, the housing member 20 with its attendant sealing structures is adapted and disposed to conformingly fit around a part of the outer circumferential surface 30 of the steering column 10, and more specifically at the firewall portion of steering column 10. The housing fits completely around such outer circumferential surface 30 of he steering column 10. As result of such latter structuring, the housing member 20 in the preferred embodiment, forms a circumferentially structured and extending sealing device with the housing being of a donut-like shape having a radially inner surface 60 and radially outer surface 70. On the radially inner circumferentially extending surface 60 of the housing 20 is a radially inwardly extending flange member 100 which has a further inwardly extending radial surface 110 with radial sides 120A and 120B extending from such flange inner surface 110 to the base radial inner surface 60 of the housing. In summary and in essence the housing 20, is a donut shaped member, in the preferred embodiment, with the donut circumferential configuration preferably, but not essentially having a center point that is the same as the center point of the steering column 10 when installed around the steering column. The donut configuration is thus adjusted to permit the housing 20 to fit securely and concentrically around surface of the steering column 10 and all around the outer circumference thereof.

In the preferred embodiment the circumferentially extending inner surface 60 of the housing member 20, with its attendant internal flange 100 is adapted to receive a flexibly constructed annular seal member 200, which seal member has a radially outer surface 210. The radially outer -surface 210 of the seal member 200 is adapted to fit conformingly against the circumferential inner surface 60 of the housing and be molded in some fashion to such inner radial surface 60 so that it is integrated permanently in such position and such that the seal 200 becomes an integrated radially inwardly directed extension of the housing member 20.

As seen in the drawings, in the preferred embodiment of the subject invention, in order to help better mold the outer radial surface of the seal 200 to the inner radial surface of the housing member 20, the outer radial surface 210 of the annular seal 200 is structured with an outer circumferentially extending channel 230 with radially outwardly projecting channel arms 240A and 240B. As seen the outer surface of seal 200 is pressed against the inner circumferential inner surface 60 of housing 20 so that the channel 230 fits snugly and conformingly over the inner radial flange 100 on the inner surface 60 of the housing 20. For this purpose, the width of the flange 100 should have the same width as the channel 230 so that the channel fits tightly over the flange 100, as seen, with the inner surface of the channel arms 240A and 240B fitted flush against the outer sides of the inner flange 100 as seen. Appropriate adhesives are used in conjunction with this process.

As seen in the drawings the inner circumferential surface of the annular seal 200 is preferably formed having an angled channel so that the inner seal surface has two circumferential contact points 260A and 260B to seat circumferentially against the outer circumferential surface 30 of the steering column 10.

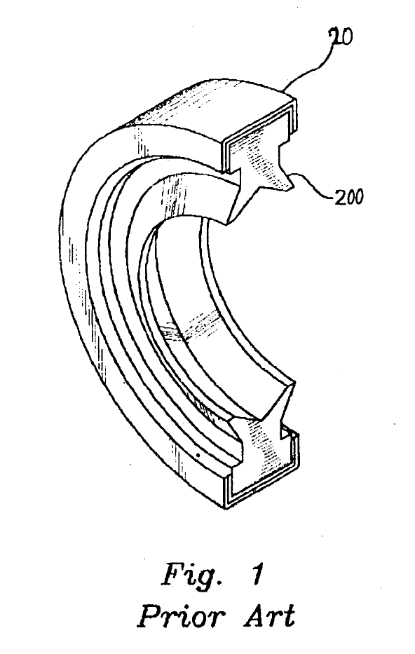

As can be seen in FIG. 2, the subject invention is an improvement over the prior art arrangement shown in FIG. 1. As seen in FIG. 1, the inner surface of the housing has a channel formed therein, while the seated flexible seal has a flange that fits within the channel on the inner housing surface. This is the opposite arrangement to the subject device, the latter of which provides superior sealing capacity.

1. cancelled

2. An apparatus for sealing part of the outer circumferential of a steering column comprising:
a) a steering column having an outer circumferential surface;
b) a housing member having an inner circumferential surface, said inner circumferential surface having an annular flange extending radially inwardly around the inner circumferential surface on said steering column, and which said annular channel extends al the way around said inner circumferential surface;
c) an annular seal having an outer circumferential surface on which is formed a radially outwardly extending annular channel extending circumferentially around said circumferential outer surface on said annular seal with said annual channel seated circumferential against and around said annular flange on said housing member, and wherein said annular channel extends circumferentially all the way around said outer circumferential surface on said annular seal.
